(19) United States
(12) Patent Application Publication
(10) Pub. No.: US 2016/0376858 A1
(43) Pub. Date: Dec. 29, 2016

(54) DRILLING FLUID PROCESSING SYSTEM AND ASSOCIATED METHODS

(71) Applicant: VERMEER MANUFACTURING COMPANY, Pella, IA (US)

(72) Inventors: James R. RANKIN, Monroe, IA (US); Gregory M. ANDERSON, Newton, IA (US)

(73) Assignee: VERMEER MANUFACTURING COMPANY, Pella, IA (US)

(21) Appl. No.: 15/039,529

(22) PCT Filed: Nov. 26, 2014
(86) PCT No.: PCT/US2014/067724

§ 371 Date: May 26, 2016

Related U.S. Application Data
(60) Provisional application No. 61/909,806, filed on Nov. 27, 2013.
(60) Provisional application No. 61/911,846, filed on Dec. 4, 2013.

(51) Int. Cl. E21B 21/06; B01D 35/28; B01D 35/027; E21B 21/01; E21B 44/00

(52) U.S. Cl. CPC E21B 21/065; E21B 21/01; E21B 44/00; B01D 35/027; B01D 35/28

(57) ABSTRACT

A processing system for separating solids from used drilling fluids to produce cleaned drilling fluids includes a cleaned drilling fluid tank and a filtering unit having an inlet container and a separating mechanism. An example filtering unit mounts to a top surface of the cleaned drilling fluids tank while a portion of the inlet container extends beneath the top surface. Certain types of flow lines may extend through the fluid tank to the portion of the inlet container. Certain types of flow lines may have multiple flow line inlets. Certain types of flow lines may have flow rate sensor arrangements.

This application is being filed on 26 Nov. 2014 as a PCT international application and claims the priority to U.S. patent application Ser. No. 61/909,806 filed on Nov. 27, 2013, and U.S. Patent Application Ser. No. 61/911,846 filed on Dec. 4, 2013, the entirety of both are hereby incorporated by reference.

### BACKGROUND

Oilfield drilling fluid serves multiple purposes in the industry. For example, the drilling fluid acts as a lubricant to cool rotary drill bits and facilitate faster cutting rates. As the drill bit pulverizes or scrapes the rock formation at a bottom of a borehole, small pieces of solid material are left behind. The drilling fluid mixes with these cuttings to form a liquid/solid slurry. The slurry is routed to a processing system at which the cuttings particulates are removed from the drilling fluid. Removing the cuttings particulates allows the drilling fluid to be reused. Furthermore, reusing the drilling fluid reduces disposal costs associated with the drilling process.

Conventional processing systems generally include several components such as a clean drilling fluid tank and a shaker having a shaker screen. The shaker is configured to perform an initial removal and separation of solid constituents of the slurry. A typical shaker includes a screen extending across a bed. The bed is vibrated (or otherwise moved) as the material to be separated is introduced onto the screen, which moves the relatively large size material along the screen. The liquid and/or relatively small sized material passes through the screen into the bed.

Improved processing systems are desired.

### SUMMARY

A processing system for separating solids from used drilling fluids to produce cleaned drilling fluids includes a cleaned drilling fluid tank and a filtering unit having an inlet container and a separating mechanism. Used drilling fluid flows from a drilling arrangement, through a flow line, through the inlet container, and onto a screen of the separating mechanism. The separating mechanism separates solid particulates from the drilling fluid.

In accordance with some aspects of the disclosure, the filtering unit mounts to a top surface of the cleaned drilling fluids tank and a portion of the inlet container is disposed beneath the top surface. For example, the used fluid inlet of the inlet container can be positioned beneath the top surface of the cleaned drilling fluid tank.

In examples, a platform is disposed over the cleaned drilling fluid tank to form the top surface. Users can walk on the platform to access components of the filtering unit. Disposing the used fluid inlet beneath the top surface causes the flow line to route underneath the platform. This positioning inhibits users from tripping over the flow line when walking across the platform.

In accordance with other aspects of the disclosure, the top surface of the cleaned drilling fluids tank defines an aperture through which a portion of the inlet container may extend beneath the top surface. In certain examples, the cleaned drilling fluids tank also defines a side port through which a flow line can extend to the portion of the inlet container.

In examples, the aperture enables the inlet container to extend beneath a platform disposed over the cleaned drilling fluid tank. The side port enables the flow line to extend to the inlet container beneath the cleaned drilling fluid tank. This positioning inhibits users from tripping over the flow line when walking across the platform. In an example, no portion of the flow line extends over the top surface of the platform.

In accordance with other aspects of the disclosure, the flow line has multiple flow line inlets. A first flow line inlet receives the used drilling fluid from the drilling arrangement. A second flow line inlet receives clean drilling fluid to inhibit a drop in flow rate through the inlet container that would result in settling of solid particulate of the used drilling fluid.

In accordance with other aspects of the disclosure, the bottom of the inlet container is narrower than a top of the inlet container. In certain examples, the inlet container includes a narrower tank section towards the bottom of the inlet container. In an example, the narrowed section facilitates flow rate of the used drilling fluid through the inlet container. In an example, the narrowed section facilitates cleaning of the inlet container (e.g., the removal of settled particulate, the removal of dumping concrete, etc.).

In an example, clean drilling fluid is supplied to the second flow line inlet when the drilling arrangement pauses operation (i.e., when the drilling arrangement pauses supplying used drilling fluid to the first flow line inlet). In other examples, clean drilling fluid is supplied to the second flow line inlet to supplement the flow of the used drilling fluid along the flow line and through the inlet container. For example, clean drilling fluid can be supplied to the second flow line inlet when the flow rate along the flow line drops below a predetermined threshold.

In an example, a charge pump for the drilling arrangement supplies the clean drilling fluid to the second flow line inlet. In another example, a separate pump or pump arrangement supplies the clean drilling fluid to the second flow line inlet.

In accordance with other aspects of the disclosure, processing used drilling fluids includes supplying clean drilling fluid to a second flow line inlet. In some examples, the clean drilling fluid is supplied to the second flow line inlet while the drilling fluid is not being supplied to the drill. In other examples, the clean drilling fluid is supplied to the second flow line inlet while clean drilling fluid also is supplied to the first flow line inlet.

In an example, the supply of clean drilling fluid to the drill is stopped so that maintenance can be performed on the drill (e.g., replacing a drill head). In another example, the supply of clean drilling fluid to the drill is stopped so that an additional piping segment can be added to a drill string of the drill arrangement. Supplying the drilling fluid to the second flow line inlet maintains at least a minimum flow rate through the inlet container to inhibit settling of the solids at the inlet container. The supply of used drilling fluids is restarted at a first flow line inlet when the drill continues (i.e., restarts) the drilling operation.

In an example, a sensor arrangement is disposed at the flow line. The supply of clean drilling fluid to the second flow line inlet is based on the readings of the sensor arrangement. For example, a drop in the flow rate through the flow line may trigger a supply of clean drilling fluid at the second flow line inlet.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic view of an example drilling system including a drilling fluid processing system and a first example routing configuration for the drilling fluid;

FIG. 2 is a schematic view of another example drilling system including the drilling fluid processing system of FIG. 1 and a second example routing configuration for the drilling fluid; an

FIG. 3 is a schematic view of example inlet containers suitable for use in the example drilling fluid processing systems of FIGS. 1 and 2; and

FIG. 4 is a schematic view of example implementation of FIG. 3 showing inlet containers suitable for use in the example drilling fluid processing systems of FIGS. 1 and 2.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

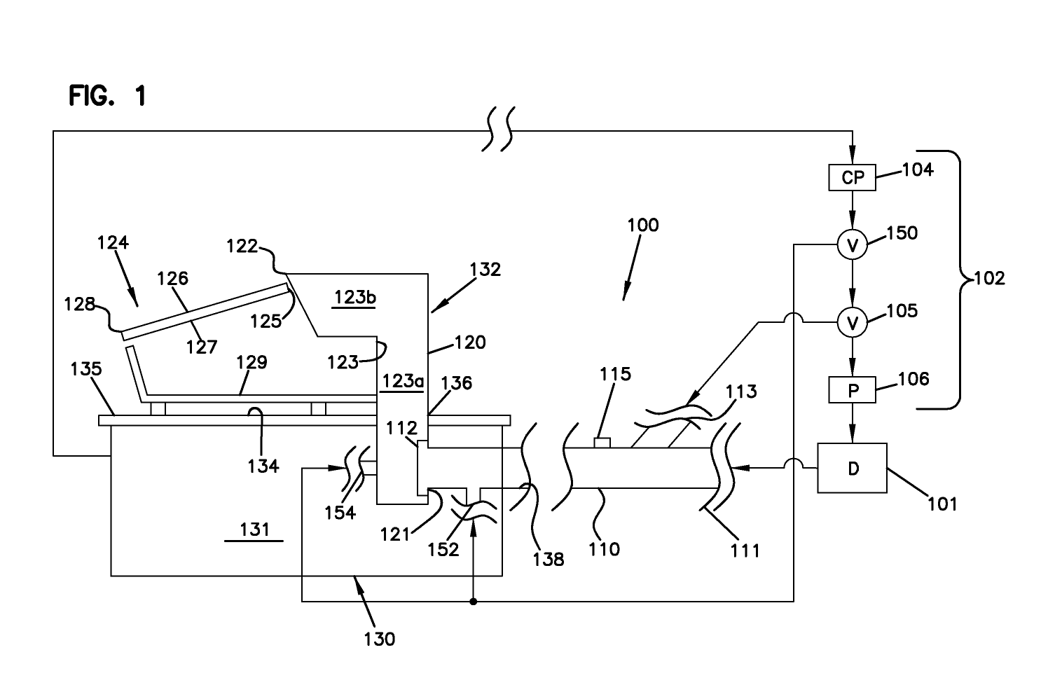

FIG. 1 illustrates a drilling system 100 including a drilling arrangement 101, a pump arrangement 102, and a drilling fluid processing system 130. The drilling arrangement includes a drill head coupled to one end of a drill string. The drill string includes one or more piping segments that are connected (e.g., threadably connected) end-to-end. During active drilling, the drill head cuts into and progresses through the ground. As the drill head progresses, additional piping segments are added to the drill string. In certain examples, active drilling pauses while the additional piping segments are added. On occasion, the drill head is replaced (or other maintenance is performed) during which active drilling is paused.

The pump arrangement 102 supplies clean drilling fluid to the drilling arrangement 101 during active drilling. At the drilling arrangement 101, the clean drilling fluid is used to lubricate the drilling arrangement 101 and/or to carry away cuttings (i.e., solids) made by the drilling arrangement 101. A flow line 110 carries the used drilling fluid including the cuttings from the drilling arrangement 101 to the drilling fluid processing system 130. For example, the used drilling fluid can enter a flow line inlet 111 at the drilling arrangement 101 and exit a flow line outlet 112 at the processing system 130.

The drilling fluid processing system 130 includes a cleaned drilling fluid tank 131 and a filtering unit 132. The filtering unit 132 is configured to remove at least some of the solid particulate/cuttings from the used drilling fluid.

In some implementations, the filtering unit 132 is one of many filtering apparatus in the processing system 130. For example, in certain implementations, multiple filtering units 132 can be disposed at the cleaned drilling fluid tank 131. The used drilling fluids can be pumped to a flow line arrangement that distributes the used drilling fluids to the various filtering units 132 for processing. In certain implementations, each of the filtering units 132 has a corresponding cleaned drilling fluid tank 131. In other implementations, two or more of the filtering units 132 output to a shared cleaned drilling fluid tank 131.

In some implementations, the drilling fluid processing system 130 also includes other processing units that pre-process or post-process the used drilling fluids. For example, the drilling fluid processing system 130 may have one or more first-stage processing units, one or more second-stage processing units, and one or more third-stage processing units. In other implementations, the drilling fluid processing system 130 may have a greater or lesser number of processing unit stages. Each stage processing unit may have a corresponding cleaned drilling fluid tank. In certain implementations, used drilling fluid can be pumped from the drill to the first-stage processing unit; processed drilling fluid output from the first-stage processing unit can be input to the second-stage processing unit (e.g., via a first cleaned drilling fluid tank); processed drilling fluid output from the second-stage processing unit can be input to the third-stage processing unit (e.g., via a second cleaned drilling fluid tank); and processed drilling fluid output from the third-stage processing unit can be output to a third cleaned drilling fluid tank. In an example, the filtering unit 132 is a second stage processing unit.

The filtering unit 132 includes an inlet container 120 and a separating mechanism 124. The inlet container 120 includes a tank 123 having a used fluid inlet 121 and a used fluid outlet 122. The used fluid inlet 121 is adapted to connect to a flow line outlet 112 of the flow line 110. Used drilling fluid flows through the flow line 110 from the drill arrangement 101, enters the tank 123 at the used fluid inlet 121, and exits the tank 123 at the used fluid outlet 122. The used fluid outlet 122 directs the used drilling fluid to the separating mechanism 124.

The separating mechanism 124 has an inlet 125 at which the separating mechanism 124 receives used fluids from the used fluid outlet 122 of the inlet container 120. The separating mechanism 124 also has a first outlet 127 for the cleaned drilling fluid and a second outlet 128 for the solids. In certain examples, the separating mechanism 124 includes a screen 126 that extends over an intermediate structure (e.g., a bed) 129. The inlet 125 is disposed towards one end of the screen 126, which is sized and configured to catch solids in the used drilling fluid while allowing drilling fluid to pass through the screen 126.

The first outlet 127 is defined along the length of the screen 126 and the second outlet 128 is defined at the opposite end of the screen 126 from the inlet 125. In certain implementations, the bed 129 and/or the screen 126 vibrates or shakes to facilitate movement of the solids across the screen 126. In some implementations, the separated drilling fluid is routed from the bed 129 back to the cleaned drilling fluid tank 131. In certain implementations, the separated drilling fluid undergoes additional processing (e.g., filtering) before reaching the cleaned drilling fluid tank 131.

In some implementations, the filtering unit 132 is disposed above the cleaned drilling fluid tank 131. For example, in certain implementations, the filtering unit 132 mounts to a top surface 134 of the cleaned drilling fluid tank 131. In certain implementations, the bed 129 of the separating mechanism 124 is disposed on the platform 135 extending across the top of the cleaned drilling fluid tank 131. In certain implementations, the top surface 134 is defined by a platform 135 that extends over the cleaned drilling fluid tank 131. The platform 135 may form a walkway for a user to access components of the filtering unit 132 (e.g., for maintenance, operation, etc.).

The inlet container 120 is disposed so that the used fluid outlet 122 is disposed above the inlet 125 of the separating mechanism 124 so that the used drilling fluid can be conveyed onto the screen 126 by flowing over a dam disposed at the used fluid outlet 122 of the inlet container 120.

In accordance with some aspects of the disclosure, the inlet container 120 is adapted and mounted so that the used fluid inlet 121 is disposed below the top surface 134 of the cleaned drilling fluid tank 131. In certain implementations, the platform 135 extends over the used fluid inlet 121 and a portion of the flow line 110 that couples to the inlet container 120 at the used fluid inlet 121. Accordingly, in certain examples, the flow line 110 does not extend over the top surface 134 of the platform 135 in the vicinity of the inlet container 120. In certain examples, no portion of the flow line 110 extends over the top surface 134 of the platform 135.

In certain implementations, a portion of the inlet container 120 can extend through an aperture 136 defined in the top surface 134 (e.g., in the platform 135) of the cleaned drilling fluid tank 131 so that the used fluid inlet 121 is positioned below the top surface 134. In other implementations, the inlet container 120 is disposed at an edge of the cleaned drilling fluid tank 131 and/or platform 131.

In some implementations, the portion of the inlet container 120 extends into the cleaned drilling fluid tank 131. In certain implementations, the cleaned drilling fluid tank 131 defines a side port 138 through which the flow line 110 can extend to enable the flow line outlet 112 to connect to the used fluid inlet 121 of the inlet container 120. In such implementations, a portion of the flow line 110 including the flow line outlet 112 is disposed within the cleaned drilling fluid tank 131.

In operation, clean drilling fluid is supplied to the drilling arrangement 101. Used drilling fluid is routed from the drilling arrangement 101, through a flow line inlet 111, along the flow line 110, through the flow line outlet 112, into the used fluid inlet 121 of the inlet container 120, through the inlet container tank 123, over the dam at the used fluid outlet 122, and onto the screen 126 of the separating mechanism 124. The solids in the used drilling fluid exit the processing system 130 through the second outlet 128. The separated drilling fluid passes through the first outlet 127 and continues through the processing system 130 to the clean drilling fluid tank 131.

In accordance with certain aspects of the disclosure, solids can settle in the inlet container tank 123 when a minimum flow rate is not maintained through the inlet container 120. In some implementations, the inlet container tank 123 is shaped and configured to enhance the flow rate of the used drilling fluid through the tank 123 from the used fluid inlet 121 to the used fluid outlet 122. For example, the inlet container tank 123 can include a narrower section 123a sized to result in a fluid velocity between the used fluid inlet and the used fluid outlet sufficient to lift the solids over the distance between the used fluid inlet 121 and the used fluid outlet 122. In certain examples, the inlet container tank 123 also includes a wider section 123b sized to facilitate even distribution of the used drilling fluid over the screen 126 of the separating mechanism 124.

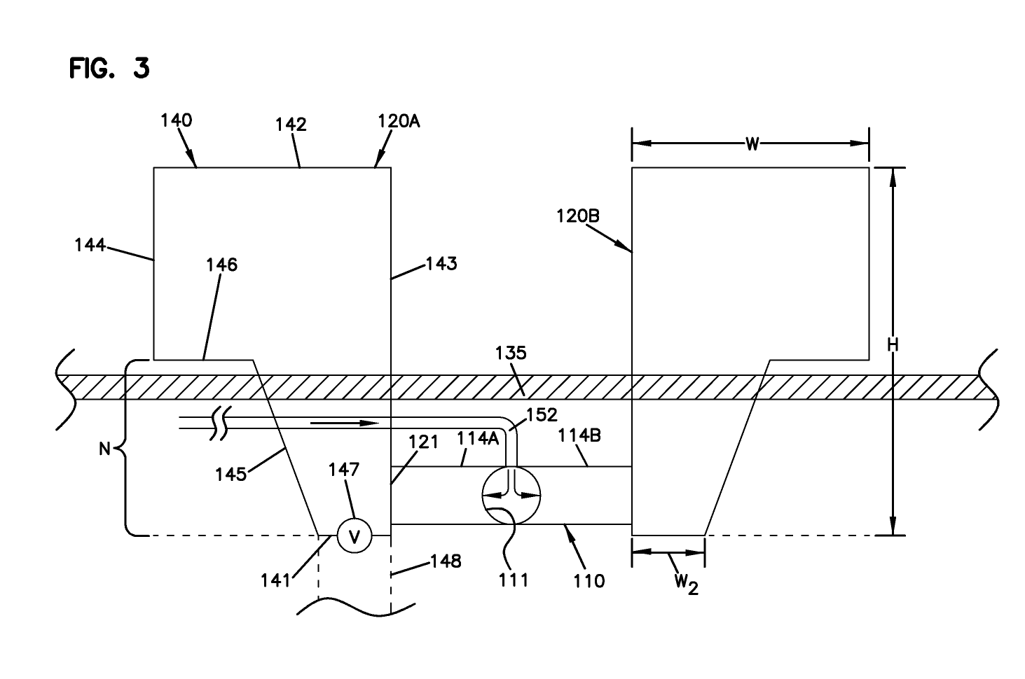

FIG. 3 illustrates a portion of an example drilling fluid processing system 130 including multiple filtering units 132. For ease in viewing, only the inlet container 120 of each filtering unit 132, a portion of the flow line 110, and a portion of the platform 135 are shown. In particular, a flow line inlet 111 is shown leading to a first inlet line 114A and a second inlet line 114B. The first inlet line 114A leads to the inlet 121 of a first inlet container 120A and the second inlet line 114B leads to the inlet 121 of a second inlet container 120B. In the example shown, the flow line inlet lines 114A, 114B are disposed beneath the platform 135 to facilitate walking on the platform 135.

In some implementations, one or more of the inlet containers 120A, 120B of FIG. 3 include an inlet container body 140 that is configured to enhance the flow rate of the used drilling fluid through the tank 123 from the used fluid inlet 121 to the used fluid outlet 122. For example, the inlet container body 140 extends along a height H between a bottom 141 and a top 142. The top 142 of the inlet container body 141 extends along a width W between a first sidewall 143 and a second sidewall 144. The inlet container body 140 includes a section N that has a narrower width than the top 142 of the inlet container body 140. The section N defines the narrower tank section 123a.

The narrower section N is located closer to the bottom 141 of the inlet container body 140 than to the top 142. In certain implementations, the narrower section N of the inlet container body 140 includes a sidewall 145 tapering inwardly as narrower section N extends towards the bottom 141. In certain implementations, the narrower section N includes an intermediate surface 146 extending inwardly from the second sidewall 144 towards the first sidewall 143. In certain examples, the sidewall 145 extends from the intermediate surface 146 to the bottom 141 of the inlet container body 140. In an example, the sidewall 145 tapers inwardly between intermediate surface 146 to the bottom 141. In another example, the sidewall 145 extends parallel to the second sidewall 144 between the intermediate surface 146 and the bottom 141 of the inlet container body 140.

In certain examples, the narrower section N extends along at least half of the height H of the inlet container body 140. In certain examples, the narrower section N extends through the platform 135. In other examples, the narrower section N is disposed fully below the platform 135. In some examples, a width W2 of the bottom 141 of the inlet container body 140 is no more than 75% of the width W of the top 142 of the inlet container body 140. In certain examples, the width W2 of the bottom 141 of the inlet container body 140 is no more than 66% of the width W of the top 142 of the inlet container body 140. In certain examples, the width W2 of the bottom 141 of the inlet container body 140 is no more than 50% of the width W of the top 142 of the inlet container body 140. In certain examples, the width W2 of the bottom 141 of the inlet container body 140 is no more than 40% of the width W of the top 142 of the inlet container body 140. In certain examples, the width W2 of the bottom 141 of the inlet container body 140 is no more than 35% of the width W of the top 142 of the inlet container body 140.

As discussed above, the narrower tank 123a of the inlet container 120 enhances the flow rate of the used drilling fluids passing through the inlet container 120. In some implementations, the narrower width W2 at the bottom 142 of the inlet container body 140 also facilitates cleaning of the inlet container body 140. For example, particulate that settles out of the used drilling fluid will typically gravitate to the bottom 141. Since the bottom 141 is narrower, there is less surface area over which the particulate may accumulate. In certain implementations, the inlet container bodies 140 includes valves 147 that selectively restrict access to waste removal tubes 148 coupled to the bottoms 141 of the inlet container bodies 140. In certain examples, the inlet container bottom 141 is sized so that at least a majority of the bottom 141 defines a port to the waste removal tube 148.

Referring now to FIGS. 1-3, in some implementations, the drilling arrangement 101 needs to pause a drilling operation for a period of time. In an example, active drilling pauses so that a piping segment can be added to a drill pipe of the drill arrangement. In another example, drilling pauses to replace the drill head of the drill arrangement during maintenance. While the drilling operation is paused, the cleaned drilling fluid is not supplied to the drilling arrangement 101. Used drilling fluid is not supplied to the processing system 130 through the flow line 110. When the supply of used drilling fluids pauses, the flow rate of the drilling fluids in the flow line 110 and/or the inlet container 120 drops. The flow rate may not be sufficient to propel solids in those used drilling fluids to the used fluid outlet 122. Accordingly, the solids may settle within the inlet container tank 123.

In accordance with other aspects of the disclosure, the flow line 110 can include a second flow line inlet 113 that provides access to the flow line 110. The second flow line inlet 113 is configured to receive drilling fluid (e.g., drilling fluid from the clean drilling fluid tank 131, drilling fluid from a different drilling fluid reservoir, etc.). The flow line 110 routes the clean drilling fluid to the inlet container 120 to maintain at least a minimum flow rate necessary to carry away solids that would otherwise settle within the tank 123.

In certain examples, the second flow line inlet 113 can enable a flow rate of drilling fluid through the inlet container 120 to be maintained as if the used drilling fluid were continuing to be supplied to the inlet container 120. In certain examples, the second flow line inlet 113 supplies less clean drilling fluid than the first inlet 111 supplied used drilling fluid, but sufficient clean drilling fluid to inhibit settling of the solids.

In accordance with other aspects of the disclosure, the flow line 110 can include a flow rate sensor arrangement 115. For example, the flow rate sensor arrangement 115 can include one or more flow rate sensors and a processor (or processors) configured to receive sensor readings and determine a flow rate along the flow line 110. If the flow rate sensor arrangement 115 determines that the flow rate is below a predetermined threshold, then clean drilling fluid can be supplied to the second flow line inlet 113 to supplement the used drilling fluid supplied at the first flow line inlet 111. The addition of the clean drilling fluid at the second flow line inlet 113 would increase the flow rate of the used drilling fluid passing through the flow line 110 and through the inlet container 120.

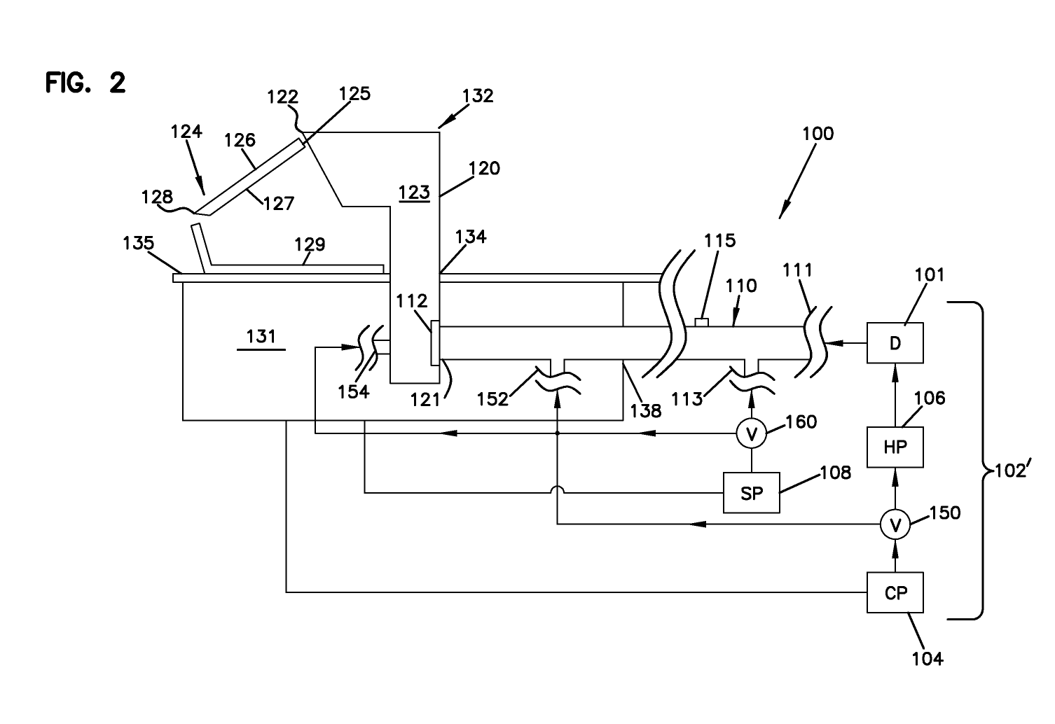

FIGS. 1 and 2 illustrate alternative example routing configurations for supplying used drilling fluid to the first flow line inlet 111 and supplying clean drilling fluid to the second flow line inlet 113. In the example routing configuration shown in FIG. 1, the first pump arrangement 102 supplies the clean drilling fluid to the drill arrangement 101 (e.g., along a first pathway) and to the second inlet 113 (e.g., along a second pathway). In certain implementations, the first pump arrangement 102 supplies the clean drilling fluid from the cleaned drilling fluid tank 131.

The first pump arrangement 102 includes a charge pump 104 and a high pressure pump 106. The high pressure pump 106 supplies the clean drilling fluid to the drilling arrangement 101. The charge pump 104 selectively supplies clean drilling fluid to the high pressure pump 106 and to the second flow line inlet 113. In certain implementations, the charge pump 104 begins supplying the clean drilling fluid to the second flow line inlet 113 when operation of the drilling arrangement 101 pauses. In certain implementations, the charge pump 104 begins supplying the clean drilling fluid to the second flow line inlet 113 when a flow rate sensor arrangement 115 disposed along the flow line 110 determines that a drop in flow rate has occurred along the flow line 110.

In certain implementations, a valve arrangement 105 is disposed between the charge pump 104 and the high pressure pump 106. In some implementations, the valve arrangement 105 includes one or more valves that direct the clean drilling fluid from the charge pump 104 towards the high pressure pump 106 or towards the second flow line inlet 113. When the drilling arrangement 101 is operational, the valve arrangement 105 directs the clean drilling fluid to the drilling arrangement 101.

In certain implementations, the valve arrangement 105 directs the clean drilling fluid to the second flow line inlet 113 when the drilling arrangement 101 is not operational (e.g., during maintenance, during the addition of one or more pipes at the drill site, etc.). In certain implementations, the valve arrangement 105 can direct the clean drilling fluid to both the high pressure pump 106 and the second flow line inlet 113. For example, the valve arrangement 105 can direct the cleaning drilling fluid to both the high pressure pump 106 and the second flow line inlet 113 when a flow rate sensor 115 disposed along the flow line 110 determines that a drop in flow rate has occurred along the flow line 110 during a drilling operation.

In certain implementations, a second valve arrangement 150 is disposed between the charge pump 104 and the high pressure pump 106, similar to the valve arrangement 105. In some implementations, the second valve arrangement 150 includes one or more valves that direct the clean drilling fluid from the charge pump 104 towards the high pressure pump 106 or towards a third flow line inlet 152 or both. In certain other embodiments, the second valve arrangement can also direct fluid flow to a fourth flow line inlet 154, located in the lower portion inlet container 120. In certain implementations, when the drilling arrangement 101 is operational, the second valve arrangement 150 can direct the clean drilling fluid to the third flow line inlet 152 and/or the fourth flow line inlet 154. The third flow line inlet 152 provides fluid to the fluid flow line 110 at a location between the used fluid inlet 121 of the inlet container 120 and the side port 138 of the cleaned drilling fluid tank 131. In such implementations, a portion of the flow line 110, the third flow line inlet 152, and the flow line outlet 112 are is disposed within the cleaned drilling fluid tank 131. In certain implementation, the fourth flow line inlet 154 is also disposed within the cleaned drilling fluid tank 131.

In certain implementations, the second valve arrangement 150 can also direct the clean drilling fluid to the third flow line inlet 152, and/or the fourth flow line inlet 154, when the drilling arrangement 101 is not operational (e.g., during maintenance, during the addition of one or more pipes at the drill site, etc.). Like the valve arrangement 105, in certain implementations, the second valve arrangement 150 can direct the clean drilling fluid to both the high pressure pump 106 and the third flow line inlet 152, and/or the fourth flow line inlet 154, when the flow rate sensor 115 determines that a drop in flow rate has occurred along the flow line 110 during a drilling operation.

In the example routing configuration shown in FIG. 2, a first pump arrangement 102′ supplies the clean drilling fluid to the drill arrangement 101 and a second pump arrangement 108 supplies the clean drilling fluid to the second inlet 113. Additionally, the second valve arrangement 150 can supply clean drilling fluid to the third flow line inlet 152 and/or the fourth flow line inlet 154. In some implementations, the third valve arrangement 160 can also supply clean drilling fluid to the third flow line inlet 152 and/or the fourth flow line inlet 154. The first pump arrangement 102′ includes a charge pump 104 and a high pressure pump 106. In the example routing configuration, the second valve arrangement 150 is positioned between the charge pump 104 and the high pressure pump 106 and configured to divert fluid flow to the third and fourth flow line inlets 152, 154, the high pressure pump 106, or all three. The second pump arrangement 108 includes one or more pumps and/or valves that direct the clean drilling fluid to the second flow line inlet 113. In certain implementations, the second pump arrangement 108 supplies the clean drilling fluid from the cleaned drilling fluid tank 131. In the example routing configuration, the third valve arrangement 160 can be positioned between the second pump 108 and the second flow line inlet 113 and can divert fluid to the third and fourth flow line inlets 152, 154, to the second flow line inlet 113, or all three. In certain implementations, the third valve arrangement 160 can provide fluid flow to the third flow line inlet 152, and/or the fourth flow line inlet 154, at the same time the second valve arrangement 150 provides fluid flow to the third flow line inlet 152. In other implementations, the third valve arrangement 160 can provide fluid flow to the third flow line inlet 152 and/or the fourth flow line inlet 154 at a time when the second valve arrangement 150 is not providing fluid flow to the third flow line inlet 152.

In certain implementations, the second pump arrangement 108 is configured to actuate during a pause in a drilling operation. In certain implementations, the second pump arrangement 108 is configured to actuate when the first pump arrangement 102 ceases to supply clean drilling fluid to the drilling arrangement 101 during the pause in the drilling operation. In certain implementations, the second pump arrangement 108 is configured to actuate when a flow rate sensor arrangement 115 disposed along the flow line 110 determines that a drop in flow rate has occurred along the flow line 110.

As shown in the implementation of FIG. 3, the third flow line inlet 152 may be positioned on the fluid flow line 110 between the first inlet line 114A and a second inlet line 114B leading to the a first inlet container 120A and the second inlet container 120B, respectively. By positioning the third flow line inlet 152 at the depicted location, fluid flow provided by the third flow line inlet 152 can assist in keeping the junction between the first inlet line 114A and a second inlet line 114B free of debris. Additionally, due to the location of the junction of the first inlet line 114A and a second inlet line 114B being at least partially under the platform 135, access is slightly restricted for maintenance (i.e. to clear a potentially clogged fluid flow line 110). By providing the third flow line inlet 152 at this location, the potential for a clogged fluid flow line 110 at the junction between the first and second inlet lines 114A, 114B is less likely. Also, by providing fluid flow at the third flow line inlet 152, it increases the chances of moving larger particles through the inlet containers 120A and 120B for processing.

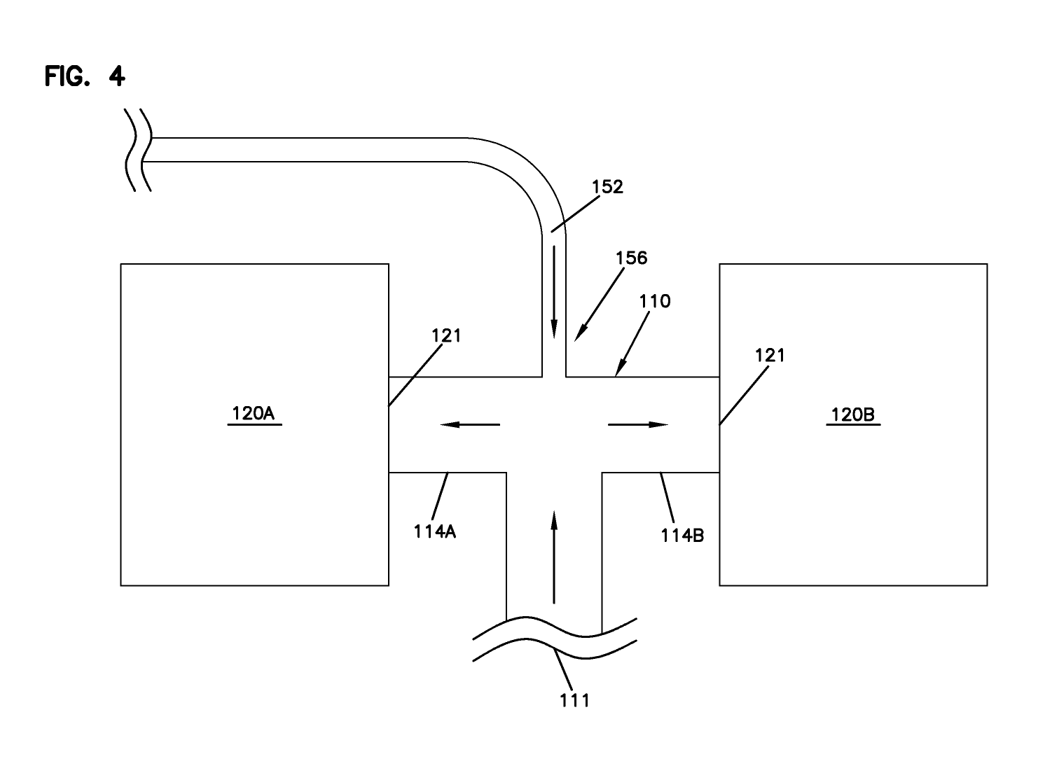

FIG. 4 shows a schematic representation of the implementation of FIG. 3. The flow line 110 is shown to have a flow line inlet 111 leading to a first inlet line 114A and a second inlet line 114B. The first inlet line 114A leads to the inlet 121 of a first inlet container 120A and the second inlet line 114B leads to the inlet 121 of a second inlet container 120B. The third flow line inlet 152 is also shown to enter the flow line 110 at the junction of the first inlet line 114A and second inlet line 114B, at a T-intersection 156. The third flow line inlet 152 can help keep the T-intersection 156 clear of debris.

It is appreciated that additional fluid flow inlets similar to 113, 152, 154 can be added to the drilling system 100 at locations on the fluid line 110 where there is slower flow rates, areas of turbulence, or bends in the fluid flow line cause sediment to settle. Specifically, fluid flow inlets can continuously or selectively enhance flow at regions of decreased flow or at regions where enhanced fluid flow is desired. Such enhanced flow can help to eliminate debris that has settled in the fluid flow line or prevent debris from settling in certain locations of the fluid flow line. Specifically, fluid flow inlets are especially helpful to maintain uninhibited flow at locations on the fluid flow line 110 where there is a T-intersection of piping.

The above specification, examples and data provide a complete description of the manufacture and use of the composition of the invention. Since many embodiments of the invention can be made without departing from the spirit and scope of the invention, the invention resides in the claims hereinafter appended.

1.-33. (canceled)

34. A processing system for separating solids from used drilling fluids to produce cleaned drilling fluids, the processing system comprising:
a cleaned drilling fluid tank having a top surface;
a filtering unit that mounts to the top surface of the cleaned drilling fluid tank, the filtering unit including:
an inlet container including a used fluid inlet and a used fluid outlet, the used fluid inlet being positioned below the top surface of the cleaned drilling fluid tank, and the used fluid inlet being adapted to connect to a flow line outlet of a flow line having a first flow line inlet; and
a separating mechanism including an inlet at which the separating mechanism receives used fluids from the used fluid outlet of the inlet container, the separating mechanism also including a first outlet for the cleaned drilling fluid positioned above the cleaned drilling fluid tank and a second outlet for the solids.

35. The processing system of claim 34, wherein the top surface of the cleaned drilling fluid tank defines a first aperture, and the body of the cleaned drilling fluid tank defines a flow line port, wherein the inlet container extends through the aperture in the top surface of the cleaned drilling fluid tank, and wherein the processing system further comprises a flow line that extends through the flow line port to the used fluid inlet of the inlet container to provide the used drilling fluids to the inlet container.

36. The processing system of claim 35, wherein no portion of the flow line extends across an exterior of the top surface of the cleaned drilling fluid tank.

37. The processing system of claim 34, wherein the top surface forms a walkway.

38. The processing system of claim 34, further comprising:
a drill configured to receive drilling fluid along a first fluid pathway and to output the used drilling fluid so that the used drilling fluid is received at the first flow line inlet;
a high pressure pump disposed along the first fluid pathway, the high pressure pump being configured to direct the drilling fluid to the drill; and
a charge pump disposed along the first fluid pathway, the charge pump being configured to direct the drilling fluid from the cleaned drilling fluid tank to the high pressure pump.

39. The processing system of claim 38, wherein the charge pump also is configured to direct the drilling fluid to the second flow line inlet along a second fluid pathway, and wherein the charge pump directs the drilling fluid to the second flow line inlet when not directing the drilling fluid to the high pressure pump.

40. The processing system of claim 38, further comprising a supplemental pump that is configured to direct the drilling fluid along the second fluid pathway to the second flow line inlet, and wherein the supplemental pump directs the drilling fluid to the second flow line inlet when the high pressure pump is not directing the drilling fluid to the drill.

41. The processing system of claim 38, wherein the flow line also defines a third flow line inlet providing access to the flow line outlet, and wherein the charge pump also is configured to direct the drilling fluid to the third flow line inlet along a third fluid pathway.

42. The processing system of claim 41, wherein the charge pump directs the drilling fluid to the third flow line inlet when not directing the drilling fluid to the high pressure pump.

43. The processing system of claim 41, wherein the third flow line inlet provides fluid to the fluid flow line at a location between the flow line port and the used fluid inlet of the inlet container.

44. The processing system of claim 34, wherein the separating mechanism includes a shaker screen disposed over the top surface of the cleaned drilling fluid tank so that a first end of the shaker screen is disposed at a first height over the top surface and an opposite second end of the shaker screen is disposed at a second height over the top surface.

45. A processing system comprising:
a cleaned drilling fluid tank configured to hold cleaned drilling fluid;
a platform extending over the cleaned drilling fluid tank to define a walkway;
a shaker screen disposed over the platform so that a first end of the shaker screen is disposed at a first height over the platform and an opposite second end of the shaker screen is disposed at a second height over the platform,
an inlet container disposed adjacent the shaker screen, the inlet container having a used fluid outlet defining a dam over which drilling fluids flow from the inlet container to the shaker screen, the inlet container also having a used fluid inlet located lower than the platform; and
a flow line extending below the platform to the used fluid inlet of the inlet container.

46. The processing system of claim 45, wherein the second height of the shaker screen is lower than the first height of the shaker screen.

47. The processing system of claim 45, further comprising an intermediate structure disposed between the platform and the shaker screen, the intermediate structure forming part of a pathway to the cleaned drilling fluid tank.

48. The processing system of claim 45, wherein the flow line extends through a side port defined in the cleaned drilling fluid tank, and wherein the used fluid inlet of the inlet container extends through an aperture in the platform and into the cleaned drilling fluid tank.

49. The processing system of claim 45, further comprising a second inlet container disposed adjacent the shaker screen, the second inlet container having a used fluid outlet defining a dam over which drilling fluids flow from the second inlet container to the shaker screen, the second inlet container also having a used fluid inlet located lower than the platform, wherein the flow line extends below the platform to the used fluid inlet of the inlet container and the used fluid inlet of the second inlet container.

50. A processing system for separating solids from used drilling fluids to produce cleaned drilling fluids, the processing system comprising:
a cleaned drilling fluid tank configured to hold cleaned drilling fluid after the solids have been separated;
a shaker screen disposed over the cleaned drilling fluid tank at an angle so that a first end of the shaker screen is disposed at a first height over the cleaned drilling fluid tank and an opposite second end of the shaker screen is disposed at a second height over the cleaned drilling fluid tank, the second height being lower than the first height;
an inlet container disposed adjacent the shaker screen, the inlet container having a used fluid outlet defining a dam over which drilling fluids flow from the inlet container to the shaker screen, the inlet container also having a used fluid inlet;
a drilling arrangement configured to push a drill string into the ground, the drill string including a plurality of drill string segments connected end to end, the drilling arrangement configured to receive drilling fluid and to output used drilling fluid; and
a piping arrangement extending at least between the drilling arrangement and the used fluid inlet of the inlet container, the piping arrangement being configured to maintain a flow rate through the inlet container between the used fluid inlet and the used fluid outlet during a drilling operation even when the drilling operation is paused.

51. The processing system of claim 50, wherein the piping arrangement is configured to supply the used drilling fluid from the drilling arrangement to the used fluid inlet of the inlet container when the drilling arrangement is actively drilling, and wherein the piping arrangement is configured to supply clean drilling fluid to the used fluid inlet of the inlet container when the drilling operation is paused.

52. The processing system of claim 50, wherein the piping arrangement is configured to supply used drilling fluid from the drilling arrangement and clean drilling fluid to the used fluid inlet of the inlet container when the drilling arrangement is actively drilling.

53. The processing system of claim 50, further comprising a flow rate sensor coupled to the piping arrangement, the flow rate sensor being configured to measure a flow rate through the piping arrangement, wherein the piping arrangement supplies the clean drilling fluid to the used fluid inlet when the drilling arrangement is actively drilling based on the flow rate measured by the flow rate sensor.
